(19) United States
(12) Patent Application Publication
(10) Pub. No.: US 2021/0028809 A1
(43) Pub. Date: Jan. 28, 2021

(54) Mobile Device Case

(71) Applicant: Catalyst Medium Four, Inc., Austin, TX (US)

(72) Inventors: Matthew Altschul, Austin, TX (US); Beejan Soheili, Chula Vista, CA (US)

(21) Appl. No.: 17/016,291

(22) Filed: Sep. 9, 2020

Related U.S. Application Data
(62) Division of application No. 29/699,533, filed on Jul. 26, 2019, now Pat. No. D901480.

(51) Int. Cl. H04B 1/3888; H04M 1/02

(52) U.S. Cl. CPC H04B 1/3888; H04M 1/0279

(57) ABSTRACT

A mobile device case includes a grip region located on the side of the case and extending into the back of case. The grip region preferably includes indented groove for a user's fingers and a higher friction grip surface compared to the back surface of the mobile device case.

The application is a divisional application of U.S. patent application Ser. No. 29/699,533, file Jul. 26, 2019, which is herein incorporated by reference in its entirety.

### TECHNICAL FIELD OF THE INVENTION

The present invention relates to protective cases, and more specifically to a protective case for a mobile electronic device.

### BACKGROUND OF THE INVENTION

The widespread use of mobile electronic devices, and mobile phones in particular, has led to the need for protective covers for such devices. Mobile devices, such as cellular phones, tablets, and personal digital assistants, are fragile as are most consumer electronics, especially so due to the extensive use of glass touch-sensing display screens. Further, the devices are expensive due to the increased capability of devices such as smartphones and required miniaturization for such powerful, portable computing devices. The combination of portability, fragility, and expense makes protective cases an important addition that is in high demand.

### SUMMARY OF THE INVENTION

An object of the invention is to provide a mobile device case with an improved grip.

A mobile device case includes a case side, a case bottom, a side plane perpendicular to the case bottom and separating the case side from the case bottom; and a grip region including at least one finger groove for a user to grip the case, the at least one finger groove present on the case side and extending past the side plane onto the case bottom. The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 is an isometric top view of a mobile device case, according to an embodiment;

FIG. 2 is an isometric bottom view of the mobile device case of FIG. 1;

FIG. 3 is a top view of the mobile device case of FIG. 1;

FIG. 4 is a bottom view of the mobile device case of FIG. 1;

FIG. 5 is a left side view of the mobile device case of FIG. 1;

FIG. 6 is a right side view of the mobile device case of FIG. 1;

FIG. 7 is a rear view of the mobile device case of FIG. 1;

FIG. 8 is a front view of the mobile device case of FIG. 1; and

FIG. 9 is a partial cross-section view of the mobile device case of FIG. 1.

### DETAILED DESCRIPTION OF PREFERRED EMBODIMENTS

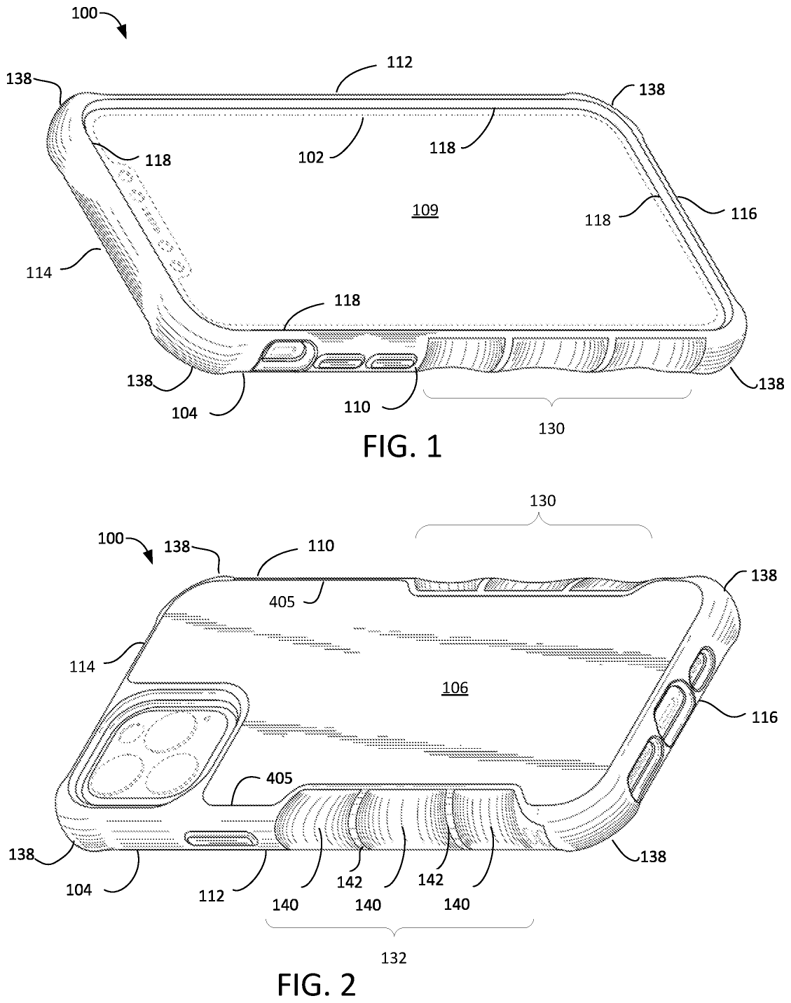

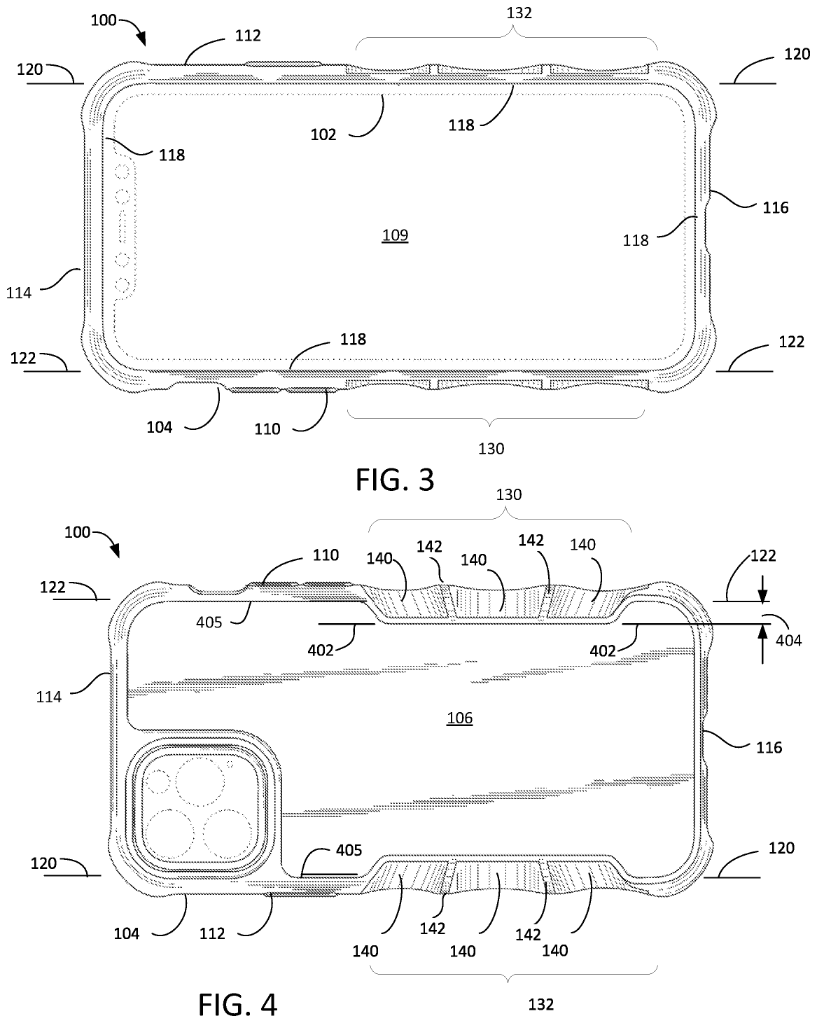

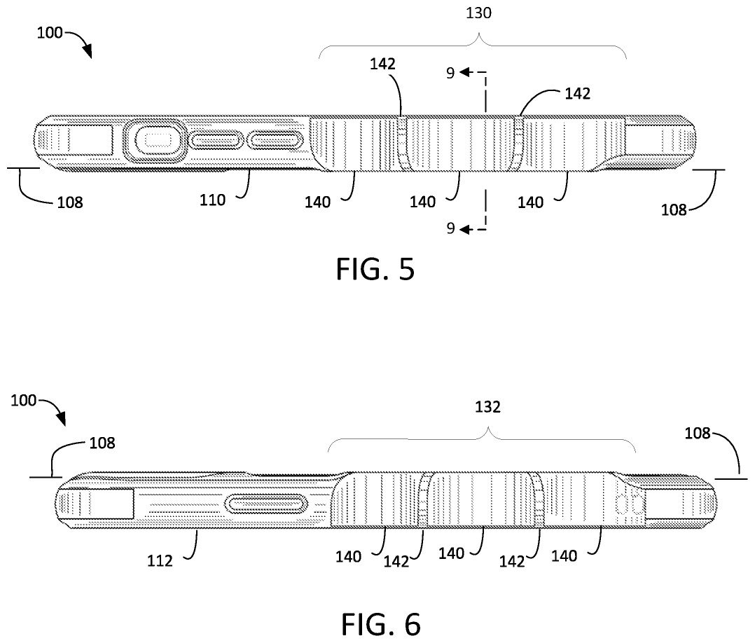

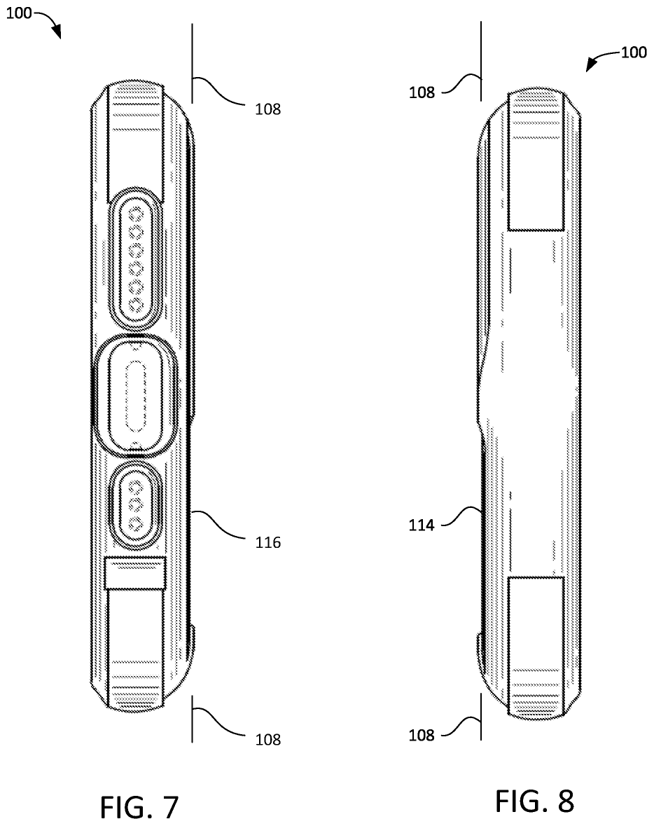

FIG. 1 is an isometric top view of an embodiment of a mobile device case 100. The dashed lines show parts of a mobile phone 102 protected by the mobile device case 100. FIG. 2 to FIG. 8 show various views that further illustrate the mobile device case 100. FIG. 2 is a bottom isometric view of mobile phone case 100. FIG. 3 is a top view and FIG. 4 is a bottom view. FIG. 5 is a left side view, and FIG. 6 is a right side view. FIG. 7 shows a rear view and FIG. 8 shows front view.

Mobile device case 100 includes a side portion 104 and a back portion 106, which can be seen in FIG. 2. Back portion 106 is not visible in FIG. 1 because it is blocked by mobile phone 102. The external surface of back portion 106 lies in, and defines, a back plane 108 shown in FIGS. 5 and 6.

Side portion 104 forms a perimeter that surrounds mobile phone 102. Side portion 104 is configured with opening and features to allow operation of the mobile phone while protected by case 100. Part of side portion 104 extends onto back plane 108. Side portion 104 can be formed as a one-piece structure, with back portion 106 formed separately and attached to side portion 104.

Parts of side portion 104 provides an enhanced grip compared to back portion 106. That is, side portion 104 provides greater friction as compared to back portion 106. Side portion 104 can be comprised of a material that has a higher coefficient of friction as compared to the material comprising back portion 106. Alternatively, side portion 104 can have a higher average surface roughness as compared to back portion 106. An enhanced grip is described in U.S. Pat. No. 9,979,429 for “Mobile Phone Case with Enhanced Grip Area and Reduced Grip Area,” which is assigned to the assignee of the present invention and which is hereby incorporated in its entirety by reference.

Side portion 104 includes a first major side case side 110, a second major case side 112, a first minor case side 114, and a second minor case side 116. A lip 118 at the top of side portion 104 extends inward from first major side case side 110, second major case side 112, first minor case side 114, and second minor case side 116. Lip 118 extend onto the top face of mobile phone 102 and prevents mobile phone 102 from falling out of case 100. The space surrounded by lip 118 defines a top case opening 109 that provides visibility of, and touch access to, the screen of mobile device 102. A direction toward the center of case 100 from any of the sides is referred to as “inward” and a direction away from the case center from any of the sides is referred to as “outward.” The corners where adjacent ones of first major side case side 110, second major case side 112, first minor case side 114, and second minor case side 116 merge are curved, each corner having a bulge 138 that extends slightly outward compared to the rest of the case side. The volume enclosed by side portion 104, back portion 106, and a front plane defined by the underside of lip 118, which volume is occupied by mobile device 102, is referred to as mobile device volume.

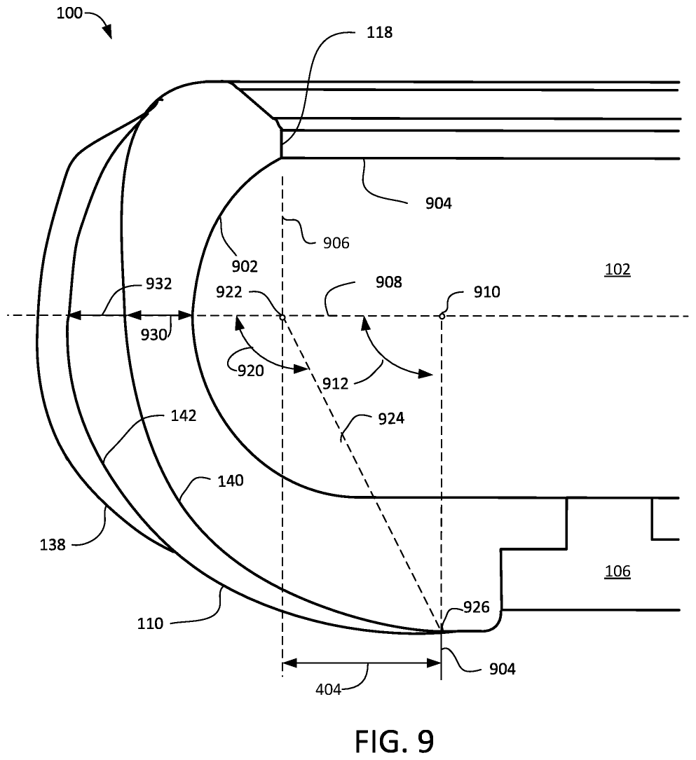

A plane through the edge of lip 118 along first major side case side 110 and perpendicular to the plane of back plane 108 is referred to as first major case side plane 122 (FIG. 3). FIG. 3 shows the edge of plane 122, which extends into the page. When a plane or line is defined using a side of case side 110, the definition refers to the straight portion of the relevant side, and not the curved portions at the corners. A plane through the distal edge of lip 118 along second major side case side 112 and perpendicular to back plane 108 is referred to as second major case side plane 120. “Side plane” can refer to major case side planes 120 and 122 or to a plane parallel to, and slightly displaced from, major case side plane 120 or 122, such as a plane passes through line 405 (FIG. 4), defined by an intersection between a part of case side portion 104 and case back portion 106. A side plane could also refer to a plane parallel to major case side plane 120 or 122 and tangent to interior surface 902 (FIG. 9) that contacts the protected mobile phone 102.

Side portion 104 includes a grip portion 130 on the first major side 110 and a grip portion 132 on the second major side 112. Grip portion 130 and grip portion 132 are mirror images of each other, and only hand grip portion 130 will be described. Each grip portion include indented finger grooves which, in addition to being on the case sides, slopes and continue to the back of the case, allowing for a more comfortable and secure grip onto the phone and prevents slippage from the user's hand. The grooves are formed by alternating valleys 140 and ridges 142. While the embodiment of case 100 includes three groves separated by two ridges, other embodiments can include two, three, four, or more grooves. The grooves have an enhanced grip surface, compared to the back portion 106.

While FIGS. 5 and 6 show ridges 142 as having flat tops, the plane of one ridge 142 angled slightly toward first minor case side 114, and the plane of the other ridge angled slightly toward second minor case side 116, any style of ridges can be used. For example, ridges 142 can have rounded tops that progress smoothly into the adjacent valleys and/or ridges 142 and the planes of the ridges can be parallel to minor case sides 114 and 116, that is, straight up and down, instead of being angled.

Prior art mobile phone cases had grooves on the sides of the case, but the grooves did not extend into the back. As shown in FIGS. 2 and 4, the grip portion 130 and 132 extend from the case sides 110 and 112 into the back. The degree of extension into the back can vary from embodiment to embodiment, and the degree of extension can be characterized in different ways, including a distance from a defined plane or line or as an angle.

As shown in FIG. 4, the pattern of alternating valleys and ridges of the grip portion extends onto the back portion 106 to a grip extent line 402. As the valleys 140 and ridges 142 approach grip extent line 402, the floor of the valleys get shallower and converge to the same level as the ridges. Grip extent line 402 is positioned inward from plane 122 by an intrusion distance 404. Distance 404 is typically between 1 mm and 10 mm, between 2 mm and 7 mm, and in some embodiments, about 3 mm. In some embodiments, distance 404 is greater than 2 mm, greater than 4 mm, greater than 5 mm, or greater than 6 mm.

While FIG. 4 measures the intrusion distance 404 from plane 122 defined by lip 118, intrusion distance 404 can also be measured using a different side plane. For example, the intrusion distance can be measured as the distance between grip extent line 402 and a line 405 defined by the intersection of side portion 104 with back portion 106 at a position away from the grip portion130. Intrusion distance can be also be measured as the distance between grip extent line 402 and a vertical plane parallel to plane 110 and tangent to an interior surface 902 of major side 110, or from the line defined by the intersection of side portion 104 with back portion 106 at a position away from the grip portion 130. In other words, the grip region 130 extends into the back plane 100 to an extent that, if the grip region were projected perpendicular to the back plane 110 onto the front opening 109, part of the finger grips of the grip region would project onto the screen of mobile phone 102.

FIG. 9 shows an enlarged partial cross section taken along lines 9-9 of FIG. 5. FIG. 9 shows first major case side 110 has an interior surface 902 that contacts an of edge mobile phone 102. The cross section of FIG. 9 cuts through one of the valleys 140. Ridge region 142 is visible behind valley 140. Corner bulge 138 is visible behind ridge 142. Valley 140 and ridge 142 extend into the back surface as far as a plane 904, which is perpendicular to back plane 108. Line 926, shown as a point where it extends into the page, indicates where the finger grooves terminate, that is, where valleys 140 and ridges 142 cease. Plane 906 extends perpendicular to the distal edge of lip 118, perpendicular to the case top opening 109. Intrusion distance 404 shows the extent that the grip portion 130 extends into the back of case 100 relative to the distal edge lip 118. A plane 908 parallel to the top opening 109 bisects the cell phone volume between the bottom of lip 118 and top of bottom portion 106. Vertex line 910 lies at the intersection of plane 904 and plane 908. Planes 904, 906, and 908 extend into the page and are shown as lines. Vertex line 910 also extends into the page and is shown as a point indicated as a small circle.

The extent that grip region 130 extends into the back of case can also be specified as an angle 912, which is measured counter-clockwise from line 908. In the embodiment shown in FIG. 9, grip region 130 extends ninety degrees from the plane 908 onto the back side of case 100. In other embodiments, angle 912 is between seventy degrees and ninety degrees. In some embodiments, vertex line 910 can also be defined as a line that runs through the center of the arc of valley 140 or ridge 142.

Yet another way to specify the extent to which grip region 130 extends into the back of the case is using angle 920, which is measured counterclockwise from line 908 to line 924. Line 924 extends from a vertex 922 at the intersection of line 908 and line 906 to line 926. Angle 920 is an obtuse angle, that is, greater than ninety degrees, and preferably greater than 100 degrees, 120 degrees, or greater than 130 degrees.

Arrow 930 indicates the thickness of the valley portion 140 of grip region 130 as measured from the inside surface 902 of side 110. Arrow 932 indicates the thickness of the ridge portion 142 of grip area 130 as measured from the inside service 902 of side 110. In one embodiment, thickness 932 is about twice the thickness of 930. In other embodiments, the intrusion angles can be measure using a side plane other than side plane 906, as discussed above with regard to measurement of intrusion distance 404.

It will be understood that because FIG. 9 is a two-dimensional cross section, features shown as line may represent planes that run into the page and such features may be referred to alternatively as line or planes in this description and features shown as points may represent lines that run into the page, and may be referred to as points or lines in this description.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A mobile device case adapted in size and shape to removably fit around the exterior of a mobile device, comprising:
a case perimeter including a first major side and a second major side, the case perimeter defining a mobile device volume having a front plane and a back plane;
a back portion connected to the case perimeter and proving a back boundary for the mobile device volume;
a grip area including multiple finger grips, the finger grips extending from at least one of the first major side and the second major side and extending along the case back plane.

2. The mobile device case of claim 1, in which the grip area extends at least 2 mm along the case back plane.

3. The mobile device case of claim 1, in which the grip area extends at least 4 mm along the case back plane.

4. The mobile device case of claim 1, in which the case perimeter includes a lip, the lip:
extending inward from the perimeter; and
defining the front plane of the mobile phone volume;
in which:
the distal edge of the lip along the first major side lies in a side plane perpendicular to the front plane of the mobile phone volume; and
the grip area extending past the side plane into the case back.

5. The mobile device case of claim 4, in which the grip area extends at least 2 millimeters extending past the side plane into the case back.

6. The mobile device case of claim 4, in which the grip area extends at least 4 millimeters extending past the side plane into the case back.

7. The mobile device case of claim 1, in which the multiple finger grips comprises exactly three finger indentations.

8. The mobile device case of claim 1, in which the multiple finger grips comprises two, three, or four finger grips.

9. The mobile device case of claim 1, wherein a vertex line is defined by the intersection of a centerline parallel to the back of the mobile device bisecting the mobile phone volume and the center of curvature of a valley, the grip area extending between 70 degrees and 90 degrees from the first plane into the back of the mobile phone device.

10. The mobile device case of claim 1 in which the grip area has a higher friction than the back portion.

11. A case for a mobile electronic device, comprising:
a case side;
a case bottom;
a side plane perpendicular to the case bottom and separating the case side from the case bottom; and
a grip region including at least one finger groove for a user to grip the case, the at least one finger groove present on the case side and extending past the side plane onto the case bottom.

12. The case of claim 11 in which the case side includes a lip configured to extend over the front of the mobile electronic device, the lip having a distal edge, and in which the side plane includes the distal edge.

13. The case of claim 11 in which an intersection line defines the intersection of the case side and the case bottom, and in which the side plane includes the intersection line.

14. The case of claim 11 in which the grip region extends onto the case bottom by at least 2 millimeters.

15. The case of claim 11 in which the grip region extends onto the case bottom by at least 4 millimeter.

16. The case of claim 11 in which:
a centerline plane is parallel to the back plane and is positioned midway between the back plane and the top opening;
an extent plane perpendicular to the bottom plane and contains the line where the grip section meets the case back; and wherein
an angle between the centerline plane and the extent plane, the angle opening towards the case side and the case bottom, is greater than seventy degrees between centerline plane.

17. The case of claim 11 in which:
a centerline plane is parallel to the back plane and is positioned midway between the back plane and the top opening;
a vertex line defined by the intersection of the side plane and the centerline plane;
a tilt line extending from the vertex to the intersection between the grip portion and the case back, the tilt line forming an obtuse angle with the portion of the centerline plane extending outward from the side plane.

18. The case of claim 11 in which friction of the grip region is greater than the friction of the case back.

19. The case of claim 11, in which the at least one finger groove comprises exactly three finger groves.

20. The case of claim 11, in which the at least one finger groove comprises two, three, or four finger grooves.
